(19) United States
(12) Patent Application Publication
(10) Pub. No.: US 2014/0159380 A1
(43) Pub. Date: Jun. 12, 2014

(54) ENERGY CONVERTING DEVICE FOR ENERGY SYSTEMS, AND METHOD FOR OPERATING SUCH A DEVICE

(71) Applicants: Kristof Schlemmer, Saarlouis (DE); Norbert Böhmer, Langerwehe (DE); Franz Fuchshumer, Altrang (DE)

(72) Inventors: Kristof Schlemmer, Saarlouis (DE); Norbert Böhmer, Langerwehe (DE); Franz Fuchshumer, Altrang (DE)

(21) Appl. No.: 13/261,797

(22) PCT Filed: Aug. 16, 2012
(86) PCT No.: PCT/EP2012/003479

§ 371 Date: Jan. 15, 2014

(30) Foreign Application Priority Data
Aug. 20, 2011 (DE) 10 2011 111 219.0

(51) Int. Cl. F03B 13/14; F03B 13/00

(52) U.S. Cl. CPC F03B 13/14; F03B 13/00
USPC 290/1 R; 290/53

(57) ABSTRACT

The invention relates to an energy converting device for energy systems (2) for convening mechanical energy into hydraulic energy and then into electric energy, said device using a control fluid (3) as the energy transporting medium. The control fluid is subjected to a variably changing pressure by at least one first converting device (5) that converts the mechanical energy into hydraulic energy. The energy converting device comprises at least one second subsequent convening device (7) that converts the hydraulic energy into electric energy. The invention is characterized in that the second convening device (7) is divided into a first control circuit (9) and a second control circuit (11), the two of which can be supplied with the control fluid (3) of variable pressure at the circuit input side (13) by the first convening device (7) and the two of which have predominantly different pressure levels.

The studies that led to this invention were funded in accordance with the Financial Aid Agreement No. 239376 under the Seventh Framework Program of the European Union (RP7/2007-2013).

The invention relates to an energy conversion device for energy systems for converting mechanical energy into hydraulic energy and from the latter into electric energy and that uses, as the energy transport medium, a control fluid, which obtains a variably changing pressure from at least one first conversion unit, which converts the mechanical energy into hydraulic energy, and with at least one second downstream conversion unit, which converts the hydraulic energy into electric energy. In addition, the invention relates to a method for operating such a device.

Renewable energy sources of the environment also include the energy of ocean waves that have an energy potential that could satisfy, according to current estimates, at least approximately 15% of the worldwide electric power demand. There exist energy conversion devices with a wide range of operating principles for the recovery of energy through the use of ocean waves.

One possible implementation principle is based on a dual-mass system that floats in water. Owing to the distinctly different natural frequencies of the two masses that are used, these two masses execute, as a function of the wave motion, different relative movements in relation to each other. Such relative movements of the masses in relation to each other can be converted into pump movements of working cylinders, like hydraulic cylinders, in order to obtain in this way, for example, by means of a generator, electric energy, which then converts the hydraulic energy into harnessed energy by means of the working cylinders in response to the mechanical energy in the form of wave motion.

Such a wave energy conversion device is disclosed in DE 601 15 509 T2 in the form of a so-called point-absorbing wave energy conversion device for recovering energy from the wave motion on the surface of a body of liquid and exhibits dimensions that are small compared to the wave length of the predominant wave. The known solution has two devices that can be moved relative to each other in the manner of two moveable individual masses, the first device having a float and the second device having a submerged body below the surface of the body of liquid. Furthermore, between these two mass devices there are hydraulic working cylinders that for an energy transfer from mechanical energy into electric energy execute stroke movements, as a function of the relative movement of the individual masses in relation to each other in response to the wave motion.

Such dual-mass systems, which float in water, are often offset in time between the wave motion and the followup movement of at least one of the masses of the dual-mass system with the result that the mass movement can be stopped or at least decelerated. This is the case, for example, when the amplitude of the wave after passing through a wave trough rises again, while at least one of the two masses following in time is still in a downward movement in the direction of the wave trough and then is slowed down or even stopped in this movement by the already rising wave. The described energy conversion is adversely affected or even stopped by this “retarding moment.”

In order to counteract these failure events, PCT-WO 2005/069824 A2 describes an energy conversion device that makes it possible, subject to the inclusion of a suitable sensor system, to briefly switch over both a generator for electric power generation in response to the wave motion and a corresponding mechanical converter segment in the form of a rack and pinion drive into a motor mode, in such a way that at least some of the previously obtained energy can be used again to drive a mass that has been set in the direction of immobilization owing to the wave motion so that the dead point phases under discussion are overcome. Then, depending on the actual circumstances of the wave motion, the energy conversion device can be used either as a generator in the energy recovery mode or in motor mode as a driving control force for the respective mass of the energy conversion device, in order to ensure in this way a basic motion situation, out of which it is easier to move the mass by the wave than if said mass assumes a decelerated state or even a quiescent state. However, despite the fact that this strategy improves the energy yield, driving the mass out of the respective wave dead point zone causes the energy to be lost again when the device is in motor mode, a feature that overall reduces the potential energy yield.

An energy conversion device according to WO 2009/153329 A2 pursues a different method for eliminating the problems in the operating state and for obtaining a higher energy yield. This known device uses a wave energy absorber that can be moved by the action of the waves and which is coupled to actuators in order to drive a plurality of actuators of a wave energy conversion device. Each actuator has a defined damping characteristic. A combination of the damping characteristics of each actuator defines a sum damping characteristic of the wave energy conversion device, a controller being used to determine the desired damping value of the wave energy conversion device as a function of the measured parameters of the wave energy absorber. Furthermore, such a controller selectively actuates one or more of the actuators in order to provide the desired damping characteristic as a function of the measured parameters of the wave energy absorber.

The magnitude, height, and frequency of a wave motion are highly variable and, thus, also the absolute value of the magnitude of motion as well as the respective relative value of the body, excited by said wave motion, in the form of the individual moveable masses. It has been proven in the field that owing to the variable behavior of the wave motion, the conversion of the mechanical energy associated with this wave motion into electric energy poses problems in the sense that no uniform electric power output is achieved and/or that as a result of the feedback processes the “mechanical wave machine” is stopped, because the respective working cylinders are stopped or at least significantly decelerated in their movement.

In order to solve these problems, WO 2009/106213 A2 proposes a generic energy conversion device that uses, as an energy transport medium, a control fluid, which is routed in two different control circuits that are operatively connected to each other for an energy transfer by means of a coupling device. In this context, the one control circuit serves to feed energy, in particular, in the form of mechanical energy; and the other control circuit serves to discharge energy in the form of converted energy, in particular, in the form of electric energy. The known division into two different control circuits allows the coupling device located between said control circuits to be operated in such a way that the energy infeed in the one control circuit is separated from the energy discharge in the other control circuit at least to the extent that when these control circuits are in operation, they do not mutually disrupt one another, with the result that adverse feedback effects, in particular, in the direction of the energy infeed for the conversion device, are reliably eliminated. However, the large number of energy conversion steps or other measures that are described in the prior art in order to counteract the described “dead point behavior” of the system generate energy losses when such energy conversion systems are in operation and, thus, a smaller energy yield for the electrical consumers that are to be connected to the respective conversion system.

Therefore, proceeding from this prior art, the object of the invention is to provide, in particular, an energy conversion device that can convert in a reliable way with almost no feedback, while at the same time retaining the advantages of the prior art, different forms of energy into one another in such a way that said device is optimized to achieve an improved energy yield with less technical complexity and effort and, thus, in a more cost-effective way.

This object is achieved by an energy conversion device having the features disclosed in claim 1 in its entirety and a method for operating such a device having the features disclosed in patent claim 11.

In that, according to the characterizing part of claim 1, the second conversion unit is divided into a first control circuit and a second control circuit, both of which can be supplied on their input side with the control fluid having variable pressure from the first conversion unit and both of which exhibit predominantly different levels of pressure, a solution is provided that helps to divide the energy, which is brought into the energy conversion device at different wave amplitudes of the upstream energy infeed device, for example, in the form of a dual-mass wave system, into different hydraulic circuits of the second conversion unit in order to improve in this way the energy efficiency of the conversion device in its entirety. Therefore, a preferred embodiment provides that in the event of wave motions of small amplitude, the energy that is brought into the conversion device is routed predominately to the first control circuit, configured as an intermediate pressure portion, with the result that the attached generator generates electric power, whereas, in the event of wave motions of larger amplitude, the associated energy content is disposed, in addition or as an alternative, in the second control circuit, configured as the high pressure portion, of the second conversion unit, in order to obtain electric energy by means of a generator or to store some of the energy inside the high pressure portion. This feature allows all or some of the stored energy portions to be used at a later date, in order to help operate the intermediate pressure portion. This is preferably the case when the wave energy infeed device can no longer feed enough energy into the conversion unit.

It is highly advantageous and surprising for the person possessing average skill in the art and working in the field of energy conversion devices that when the wave motion decelerates or stops, the first conversion unit can be totally decoupled from the second conversion unit, and yet it is possible to continue to obtain electric energy with the second conversion unit by retrieving the energy from the high pressure portion in the direction of the intermediate pressure portion, so that it is not necessary, as is also illustrated in the prior art, to keep operating the wave energy infeed device by means of feedback with an energy return flow in the opposite direction, in order to counteract the described “dead point behavior.”

Since preferably both conversion units are part of a common single fluid-conducting control circuit comprising a control fluid having variable pressure, the mechanical energy can be converted by way of the hydraulic energy into electric energy in a few conversion steps. In terms of energy, this approach is better than if the energy conversion under discussion is carried out with two separate control circuits and a plurality of conversion steps associated with these control circuits.

The intermediate pressure portion and the high pressure portion can be connected together in parallel inside the common control circuit. This feature allows the hydraulic energy to be converted into electric energy in the second conversion unit using the total volume flow of, on the one hand, the control fluid having variable pressure and, on the other hand, the control fluid having high pressure at an almost constant pressure level. In this way, the energy yield can be increased, and the conversion of hydraulic energy into electric energy by means of the energy conversion device can also be kept largely constant for the attached electrical consumers.

In an especially preferred embodiment of the energy conversion device, the intermediate pressure portion and the high pressure portion can be configured so as to be separable from each other by means of a valve mechanism on the input side of the energy conversion device. The valve mechanism is configured even more preferably as a nonreturn valve, which opens preferably in the direction of flow from the intermediate pressure portion to the high pressure portion and vice versa closes. This feature allows the pressure level of the high pressure portion on the input side to be decoupled from that of the intermediate pressure portion for the operating mode described above.

Another design feature for configuring the energy conversion of hydraulic energy into electric energy in a reliable way without feedback and largely constant is to use an adjustable hydraulic motor in the intermediate pressure portion and in the high pressure portion. Then said hydraulic motors can be connected jointly to an electric generator. The displacement volume of the hydraulic motors can be varied continuously by means of a suitable adaptive control, which considers preferably the pressure profile of the variable pressure of the control fluid on the input side and the pressure of the control fluid in the high pressure portion as well as the actual speed of the hydraulic motors, with the result that the shaft velocity is as constant as possible for the respective generator.

In that the input side of the high pressure portion is provided with at least one hydraulic accumulator, it is then possible to smooth out the variations in pressure generated by the control fluid in the high pressure portion and to store, moreover, the energy introduced by the wave system on the high pressure side. The first conversion unit has at least one hydraulic working cylinder, which converts, as the infeed device, the mechanical wave energy of a wave system into hydraulic energy exhibiting a variable pressure portion. Multiple rows of the first and the second conversion unit can be coupled together to form an expanded complete system. This design feature makes it possible to increase both the power output level of the energy conversion device and to even out, in particular, the operation of the respective generator.

It may be advantageous to design the series connection of the conversion units in such a way that the result is a type of cascade arrangement. Then a desired level of electric energy can also be drawn from the energy conversion device as a function of the actual input of mechanical energy into the energy conversion device. At the same time, it can also be advantageous to configure each row of first and second conversion units with a specific maximum electric power output, so that the individual rows can be distinguished from each other by their maximum electric power output. Then the intermediate pressure portions and the high pressure portions can also be used inside each row of first and second conversion units in such a way that the quantity of control fluid, which exhibits a low or intermediate pressure and is delivered by the first conversion unit and comes preferably from the intermediate pressure portion, and the quantity of control fluid, which exhibits a pressure that is comparatively higher than the former and comes preferably from the respective high pressure portion, can be converted into electric energy.

The aforementioned cascade-like configuration allows a first row of first and second conversion units to be assigned to a very small wave motion so as to match the energy input; and a second comparable row, to a wave motion with average amplitude; and optionally a third row, to the wave motions with a very large amplitude. This feature allows each energy conversion device to be matched with the respective prevailing wave motions for an optimal operating range.

In addition, the first conversion units of different rows can be combined in any way with one or more second wave conversion units of other rows, so that the result is a finer gradation when matching with the operating range. Under some circumstances, the energy conversion device according to the invention can also be used in the context of operating wind energy systems or the like. Then the first conversion unit does not have hydraulically actuated working cylinders, but rather has, for example, a hydraulic pump. This approach would also make it possible to even out the energy output by means of the aforementioned high pressure portion of the second conversion unit. It is also conceivable, to use, instead of a dual-mass wave energy system, other wave energy infeed systems with masses that can be moved by waves and are arranged, for example, side by side in succession, like a chain.

The inventive solution to the problem is also achieved by a method according to the independent patent claim 11. This method is used to operate, as described above, an energy conversion device, so that the quantity of fluid exhibiting a low pressure and delivered by the first conversion unit and coming preferably from the intermediate pressure portion, and the quantity of fluid, having a pressure that is higher than the former and coming from the high pressure portion, are converted into electric energy.

The energy conversion device is explained in detail below by means of an exemplary embodiment with reference to the drawings. The figures are schematic drawings not drawn to scale.

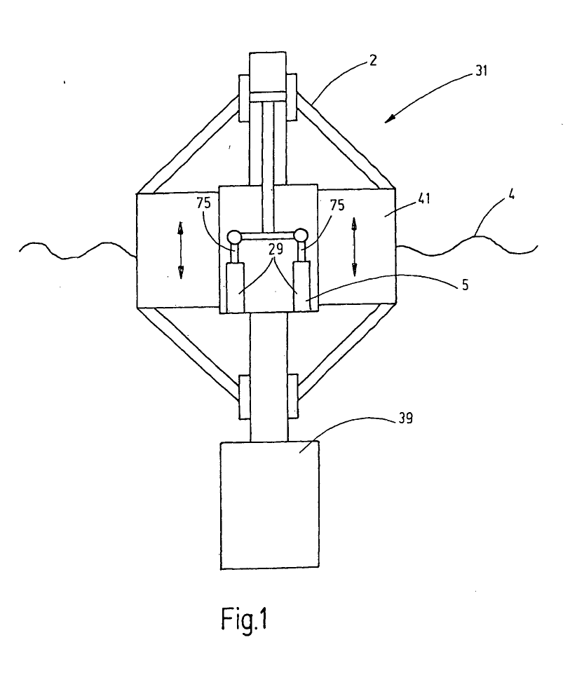

FIG. 1 shows the basic structure of a wave energy infeed device as a dual-mass oscillating system as the energy system for connecting to an energy conversion device;

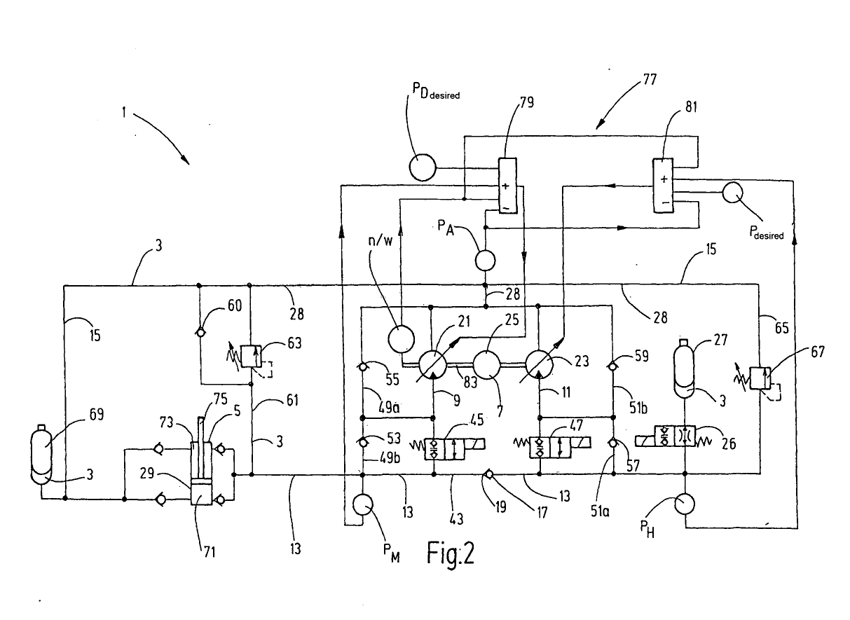

FIG. 2 shows, as a hydraulic circuit diagram, one exemplary embodiment of the energy conversion device according to the invention;

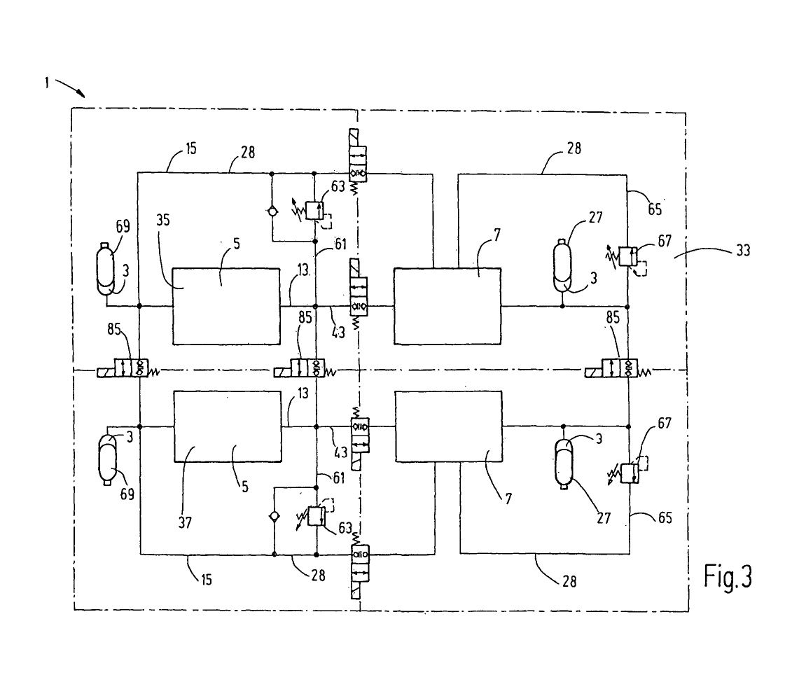

FIG. 3 shows, as a hydraulic circuit diagram, the whole system comprising two rows of energy conversion devices, each of which consists of a first and second conversion unit; and

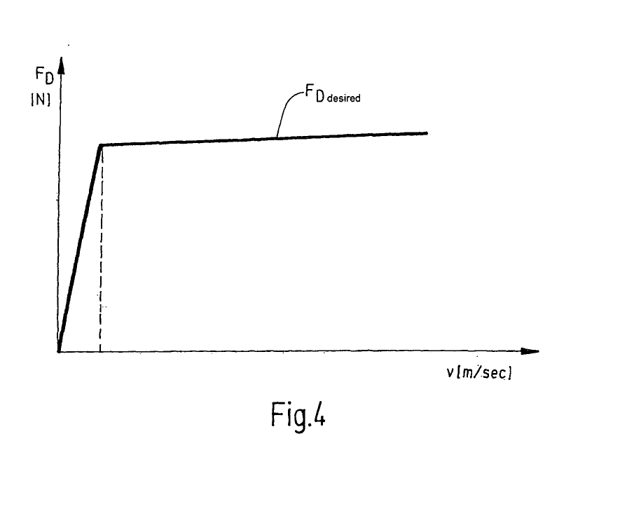

FIG. 4 shows, as a schematic diagram, the profile of the desired damping force F_{D,desired} plotted over the relative velocity v between the floats of a wave energy system.

FIG. 1 is a highly simplified schematic block diagram of the basic structure of a wave system 31 as an energy infeed device. The wave system 31 is constructed like a floating buoy and has a first float body, as a post float 39, and a second float body, as an annular float 41, which radially surrounds said post float. The post float 39 has a larger mass than the annular float 41, and, thus, forms a dual-mass wave energy system, as shown, for example, in the above-described DE 601 15 509 T2. As a result, the post float 39 has a lower natural frequency than the annular float 41. The annular float 41 can be moved axially relative to the post float 39. The ocean waves 4, which surround the wave system 31 and move past the wave system 31, cause the annular float 41 to execute continuously an axial relative movement (shown in FIG. 1 with two double arrows) relative to the post float 39, so that as the amplitude of the wave motion increases, the indicated axial relative movement increases, a state that results in an increase in the working capacity of the wave system 31.

The wave system 31, which is configured as an energy system 2 or an energy infeed device, is connected upstream of an energy conversion device 1, as shown by its basic configuration in the hydraulic circuit diagram in FIG. 2. The energy conversion device 1 can be an integral component of the wave system 31 according to FIG. 1. However, it is also possible to connect, according to FIG. 2, a plurality of floating buoys to an energy conversion device 1 so as to be hydraulically “connected together” in the manner of a field of energy systems (not illustrated). The energy conversion device 1 serves to convert mechanical energy into hydraulic energy and from the latter into electric energy, with the result that the mechanical energy is recovered from the relative movement of the annular float 41 relative to the post float 39. Furthermore, the energy conversion device 1 has a control fluid 3, which is used as the energy transport medium. The control fluid 3 is provided with a variably changing pressure P_{M} by at least a first conversion unit 5, which converts the mechanical energy into hydraulic energy. Furthermore, the energy conversion device 1 has a second conversion unit 7, which converts the hydraulic energy into electric energy.

The second conversion unit 7 is divided into an intermediate pressure portion 9 as the first control circuit, and a high pressure portion 11, as the second control circuit. The first conversion unit 5 supplies the intermediate pressure portion 9 and the high pressure portion 11 with the control fluid 3 of variable pressure P_{M} on their input side 13. Both conversion units 5, 7 are a part of a common fluid-conducting central control circuit 15, which is configured as a type of closed loop circuit in the exemplary embodiment shown in FIG. 2. The intermediate pressure portion 9 and the high pressure portion 11 are connected together in parallel inside the common control circuit 15 and can be separated from each other on their input side 13 by a valve mechanism 17, which is constructed as a nonreturn valve 19 in the illustrated embodiment in FIG. 2. The nonreturn valve 19 can be traversed by flow from the intermediate pressure portion 9 to the high pressure portion 11 and blocks in the reverse direction of flow.

The intermediate pressure portion 9 and the high pressure portion 11 have in each case one adjustable hydraulic motor 21, 23 having variable displacement volume. Both hydraulic motors 21, 23 are used to drive jointly a generator 25 for recovering electric energy. In an embodiment that is not shown in detail, it would also be possible for each portion 9, 11 of the second conversion unit 7 to be provided with its own generator, instead of one generator 25. As shown on the right side when seen in the viewing direction of FIG. 2, the high pressure portion 11 is provided with a hydraulic accumulator 27, which can be connected to the input side 13 of the said high pressure portion 11 by means of the stop valve 26. The stop valve 26 can isolate the hydraulic accumulator 27 from the rest of the hydraulic common control circuit, a state that can be utilized to generate briefly an increase in pressure in the high pressure portion beyond the level of the pressure of the accumulator. Between a control fluid line 43, forming the input side 13 of the high pressure portion 11 and the intermediate pressure portion 9, and the hydraulic motor 21, there is an electrically actuated 2/2-way valve 45. Between the control fluid line 43 and the hydraulic motor 23, there is in turn a 2/2-way valve 47 exhibiting the same functions. The valves 45, 47 serve in each case to block the inflow of control fluid 3 to the respective hydraulic motors 21, 23 or to drive said motor with control fluid 3. Hence, the intermediate pressure portion 9 and the high pressure portion 11 lend themselves well, as a function of the switching position of the valves 45, 47, to providing, even individually, for the drive of the generator 25, and, in particular, independently of the momentary adjustment of the respective displacement volume of the hydraulic motors 21, 23 that can also be adjusted to a zero displacement flow rate.

The intermediate pressure portion 9 has a bypass line 49a, which is provided with a nonreturn valve 55 and connects the inflow of the hydraulic motor 21 on the intermediate pressure side to the output side 28 of the control circuit 15. The bypass line 49a makes it possible for the hydraulic motor 21 to continue to draw the control fluid 3 from the output side 28 in the event that the supply of control fluid suddenly stops, for example, on closing the valve 45, so that there is no risk of cavitation phenomena occurring due to the inertia-induced run-on of the hydraulic motor 21. In the reverse direction, the nonreturn valve 55 closes. A second bypass line 49b, which is provided with a non-turn valve 53, allows excess control fluid to drain in the direction of the input side when the pressure at the inflow of the hydraulic motor 21 increases beyond the pressure on the input side 13. Similarly, the high pressure portion 11 has two bypass lines 51a and 51b, which have nonreturn valves 57, 59 and which fulfill the same functions for the hydraulic motor 23 on the high pressure side, as shown by means of the bypass lines 49a, 49b and the nonreturn valves 53, 55 for the hydraulic motor 21 on the low or intermediate pressure side.

The first conversion unit 5 is provided with a bypass line 61 between the input side 13 and the said output side 28. The bypass line 61 has a pressure limiting valve 63, which is connected in parallel arrangement to a nonreturn valve 60. The second conversion unit 7 has an additional third bypass line 65 between the input side 13 and the output side 28 and, in particular, at the end of the control circuit 15, at which the high pressure on the input side is transferred into an intermediate pressure circuit, which forms the output side 28 of the common control circuit 15. Such a third bypass line 65 has in turn a pressure limiting valve 67. The two pressure limiting valves 63, 67 serve chiefly to protect the input side 13 of the control circuit 15 and its components from the excess pressure of the control fluid 3. If the situation arises that an excessively high input power at the first conversion unit 5 leads to a surplus of control fluid that cannot be totally processed by the second conversion unit 7, then the control fluid is discharged in the direction of the output side by means of the pressure limiting valves 63, 67.

The first conversion unit 5 has, as the actuator, a hydraulic working cylinder 29, in the manner of a synchronization cylinder. For the sake of a simpler drawing, FIG. 2 shows only one working cylinder 29 for the first conversion unit 5, whereas the drawing according to FIG. 1 shows two working cylinders 29 as an essential part of the first conversion unit 5. Furthermore, FIG. 1 shows that said actuators or working cylinders 29 are connected to the energy system 2 in such a way that the wave motions can be converted into working movements of the piston rod component 75 of the respective working cylinder 29. To the extent that the hydraulic working cylinder 29, depicted in FIG. 2, is designed as a type of synchronization cylinder, this means that in the opposite direction of movement of the piston rod component 75, an identical quantity of fluid, which has the same fluid pressure and comes from both the working chamber 71 and the working chamber 73, flows to the input side 13 of the second conversion unit 7.

In addition, a hydraulic accumulator 69 is positioned upstream of the hydraulic working cylinder 29 on the input side with the task of serving to prestress the control fluid 3 in the direction of the respective working chambers 71, 73 and in the working chambers themselves. This approach makes it possible to eliminate any undesired cavitation phenomena. The conversion unit 5, depicted in FIG. 2, implements the synchronization characteristics in such a way that a differential cylinder 29 is properly combined with a row of nonreturn valves, with the result that the unequal area cylinder assumes with respect to the pumped volumetric flow rate and pressure the described behavior of an equal area cylinder.

In order to operate the energy conversion device according to FIG. 2, there is a control unit, which is designated as a whole as 77 and which is provided, in particular, with two controllers 79 and 81, for example, in the embodiment of a PID controller. The controller 79 receives, as the input variable, the variable pressure value P_{M} on the intermediate pressure side; and the controller 81 receives, as the input variable, the high pressure value P_{H} on the high pressure side of the input side 13 of the control circuit 15. Such a pressure value input is compared, based on the controller 81, with a specifiable desired value P_{desired}, which originates, for example, from a computer unit (not illustrated in detail). The input pressure p_{D,desired} for the controller 79 is taken from the damping force characteristic according to FIG. 4, converted to the damping pressure in the working cylinder 29. Following a linear increase in the damping pressure, which is apparent from the steep flank of the force profile in the diagram depicted in FIG. 4, the pressure in the accumulator 27 is held at a predefinable pressure level, which reaches, as the input variable p_{D,desired}, the controller input side of the controller 79.

Preferably, the energy conversion device 1 according to FIG. 2 is adjusted to this desired input value of the accumulator 27. Since the intermediate pressure portion of the conversion unit 7 is separated from the high pressure portion comprising the hydraulic accumulator 27 by means of the nonreturn valve 17 and does not have its own accumulator, the intermediate pressure portion is characterized by a high hydraulic stiffness that makes it possible to control with a high degree of accuracy the damping pressure p_{D} and, thus, the damping force F_{D} in the range of the linear ascent in FIG. 4. At the same time, the said input variable P_{Ddesired} is balanced, within the bounds of possibilities of the controller 79, with the pressure input variable P_{M}, coming from the intermediate pressure side. An additional input variable that must be considered at the controllers 79 and 81 is the output-side pressure value P_{A}, which is tapped on the output side 28 of the common control circuit 15. Furthermore, both controllers 79 and 81 obtain a speed value input n and/or information about the angular speed ω of a shaft 83 of the generator 25 on its input side, whereas on the output side both controllers 79, 81 specify the displacement volume of the hydraulic motors 21, 23 as the manipulated value.

For said actuation of the hydraulic motors 21, 23, these motors are configured preferably as axial piston machines with a swiveling angle that can be actuated continually by the said control unit 77 using actuating elements that are not illustrated in detail. The construction of such hydraulic motors is well known, so that there is no need to go into the detail at this point.

In summary, it must be observed that the energy conversion device with its assigned control unit 77 permits rapid actuation and control operations in order to adjust the desired damping force and, thus, to convert the introduced wave energy into electric energy by means of said conversion units 5, 7.

In order to better understand the energy conversion device according to the invention, its function and operating principle are explained in detail below. The actuation that is intended for the respective actuator or working cylinder 29 and that is provided, as a function of the wave motion, by the energy system 2, results in an infeed of control fluid having a variably changing pressure P_{M} on the input side 13 of both the intermediate pressure portion 9 and the high pressure portion 11. In phases of low infeed as a consequence of low relative velocities, the conversion of the newly supplied energy by means of the intermediate pressure portion 9 with the hydraulic motor 21, which drives the generator 25, is initiated in parallel to the conversion of the stored energy. The excess fluid volume portions, which are generated at higher infeed and which are not accommodated by the intermediate pressure portion 9, are conveyed in the direction of the high pressure portion 11, where they are fed into the hydraulic accumulator 27, and from there can be used directly to operate the additional hydraulic motor 23, which in turn is actuated by the control unit 77 (taking into consideration the diagram according to FIG. 4) and drives the generator 25.

If at this point the intermediate pressure side or the high pressure side should be undersupplied, then the quantity of energy can be retrieved from the hydraulic accumulator 27, and the generator 25 can be actuated by means of the hydraulic motor 23 of the high pressure portion 11. Hence, there is the possibility of reliably converting a plurality of wave processes into electric energy with a single energy conversion device 1.

In the event of wave motions with a distinctly high amplitude, the system is protected against overload by re-routing the fluid again to the low pressure side of the control circuit 15 by means of the pressure limiting valve 63. It has been proven to be especially advantageous in terms of energy to operate the whole system at the damping force desired value F_{desired} that affects, according to the drawing from FIG. 4, the damping behavior of the energy conversion device. It is self-evident that the hydraulic circuit diagram according to FIG. 2 is a simplified schematic drawing and that, in particular, the above-described components, like the working cylinder, the hydraulic accumulator, the motors, the switching valves, and the like, can also be arranged differently.

FIG. 3 shows, as a hydraulic circuit diagram, the entire system 33, which is enlarged in terms of throughput capacity. In the present embodiment, the whole system comprises, according to FIG. 2, two rows 35, 37 of two energy conversion devices each. In this case, the same components bear the same reference numerals, as shown in FIG. 2; and the respective designs also apply correspondingly to the embodiment according to FIG. 3.

In addition to the redundant design that allows, for example, the system to continue working with the still functioning energy conversion device when the other energy conversion device 1 has failed, the above-described solution also makes it possible to perform maintenance work on an energy conversion device 1 that has been shut down, while the other is still running. However, preferred is a cascade mode that makes it possible to use different rows 35, 37 of conversion devices 1 to cover different wave ranges when the energy system 2 is running. Thus, for example, the one row 35 can utilize smaller wave amplitudes and can use them for energy conversion, whereas the other row 37 is put into operation in the event of waves of higher amplitudes. Switching valves 85, which are disposed between the rows, serve to couple together the two rows 35, 37.

The solution according to the invention does not have to be limited to use in wave systems 31, but rather can also be used for other energy systems. Thus, an “intermittently” working displacement device, such as a hydraulic pump or the like, can replace the illustrated working cylinders 29 for the first conversion unit 5.

1. An energy conversion device for energy systems (2) for converting mechanical energy into hydraulic energy and from the latter into electric energy and that uses, as an energy transport medium, a control fluid (3), which obtains a variably changing pressure from at least one first conversion unit (5), which converts the mechanical energy into hydraulic energy, and with at least one second downstream conversion unit (7), which converts the hydraulic energy into electric energy, characterized in that the second conversion unit (7) is divided into a first control circuit (9) and a second control circuit (11), both of which can be supplied on their input side (13) with the control fluid (3) having variable pressure from the first conversion unit (7) and both of which exhibit predominantly different levels of pressure.

2. The energy conversion device according to claim 1, characterized in that the predominantly prevailing pressure level of the first control circuit (9) can be classified as the intermediate pressure and that of the second control circuit (11) as the high pressure.

3. The energy conversion device according to claim 1, characterized in that the two conversion units (5, 7) are a part of a common fluid-conducting control circuit (15).

4. The energy conversion device according to claim 1, characterized in that the intermediate pressure portion (9), as the first control circuit, and the high pressure portion (11), as the second control circuit, are connected together in parallel inside the common control circuit (15).

5. The energy conversion device according to claim 1, characterized in that the intermediate pressure portion (9) and the high pressure portion (11) can be separated from each other on their input side (13) by a valve mechanism (17), preferably in the form of a nonreturn valve (19).

6. The energy conversion device according to claim 1, characterized in that the intermediate pressure portion (9) and the high pressure portion (11) have in each case an adjustable hydraulic motor (21, 23), both of which are connected jointly to a generator (25).

7. The energy conversion device according to claim 1, characterized in that the high pressure portion (11) has on its input side (13) at least one hydraulic accumulator (27).

8. The energy conversion device according to claim 1, characterized in that the first conversion unit (5) has at least one hydraulic working cylinder (29), which converts the mechanical wave energy of a wave system (31) into hydraulic energy having variable pressure (P_{M}).

9. The energy conversion device according to claim 1, characterized in that multiple rows (35, 37) of first and second conversion units (5, 7) are coupled together so as to form an expanded complete system (33).

10. The energy conversion device according to claim 1, characterized in that the series connection of the conversion units (5, 7) is executed so as to achieve a cascade arrangement.

11. A method for operating an energy conversion device according to claim 1, characterized in that the quantity of fluid, which is delivered by the first conversion unit (5) and which has a low or intermediate pressure (P_{M}) and comes preferably from the intermediate pressure portion (9), and the quantity of fluid, which exhibits a pressure (P_{H}) that is higher than that of the former and which comes preferably from the high pressure portion (11), are converted into electric energy.
